(19) United States
(12) Patent Application Publication
(10) Pub. No.: US 2007/0094120 A1
(43) Pub. Date: Apr. 26, 2007

(54) System and method for providing integrated hedge accounting in parallel valuation areas

(76) Inventors: Ulrich Haenle, Walldorf (DE); Frank R. Laqua, Schwetzingen (DE); Klaus G. Mueller, Neustadt a.d. Weinstrasse (DE); Stefan Schmid, Wiesloch (DE)

Correspondence Address: KENYON & KENYON LLP, ONE BROADWAY, NEW YORK, NY, 10004, US

(21) Appl. No.: 11/256,043

(22) Filed: Oct. 21, 2005

(51) Int. Cl. G06Q 40/00

(52) U.S. Cl. 705/36 R

(57) ABSTRACT

In a system and method for providing hedge accounting data for a plurality of hedging relationships, a processor may store a plurality of risk exposure data objects, hedging instrument data objects, hedging relationship data objects, and rule set data objects, may assign the same exposure data objects and hedging instrument data objects to each of the plurality of hedging relationship data objects or to each of a subset thereof, for example where each of the plurality of hedging relationship data objects or the subset thereof corresponds to a different one of the plurality of rule set data objects, and may generate hedge accounting data for a particular one of the plurality of hedging relationships according to a plurality of rule sets in response to a single user instruction.

### BACKGROUND

Business entities, e.g., banks, enter into a large number of transactions in the ordinary course of their operations. Some of these transactions carry financial risk. For example, with respect to individual loans, the risks typically include a risk of debtor default, risks presented by changing interest rates for variable rate loans or imminently mature loans (whose principal likely will be reinvested at a new interest rate), or risks based on an exposure to an exchange rate between currencies of different countries. Typically, banking regulations require that the business entities own instruments, typically derivatives such as options, whose behavior counterbalances risks presented by the transactions. This is called “hedging.” The regulations also require the entities to provide an accounting of these transactions, e.g., by preparing financial statements indicating an entity's profits, losses, and equity positions in accordance with the transactions. Hedged risk exposures presented by a first, typically large, set of instruments are counterbalanced by performance of a second, typically much smaller, set of instruments (called “hedging instruments” herein), such that when risk rises in the hedged risk exposures, risk falls in the hedging instruments. For example, a set of instruments are grouped and treated as a single exposure that is to be hedged. The set of instruments is therefore a single hedged risk exposure. One or more hedging instruments counterbalance the risk exposure caused by the set of instruments of the single hedged risk exposure.

Conventional computer applications aid in the organization and management of a business entity's risk exposures and hedging instruments. The risk exposures and hedging instruments are stored in the system as exposure data objects and hedging instrument data objects, respectively. The risk exposures and their corresponding hedging instruments are grouped into corresponding hedging relationships by creating for each risk exposure to be hedged at least one corresponding data object, called a “hedged item” data object herein, and assigning the hedged item data object and one or more hedging instrument data objects to a hedging relationship data object.

A hedging relationship data object therefore associates one or more particular hedging instrument data objects with particular hedged item data objects (and therefore associates one or more particular hedging instruments with particular risk exposures). Hedge accounting data is generated for a hedging relationship to indicate how and to what extent the hedging instruments of the relationship counterbalance the exposure of the relationship's hedged items. For a given hedged item(s) and corresponding hedging instrument(s), relationship data differs depending on the particular method and set of regulations followed to determine the relationship data. For example, typical methods that are alternatively applied are a “cash flow” method, according to which the cash flows of the counterbalanced hedged items and hedging instruments are compared, and a “fair value” method, according to which the fair values of the counterbalanced hedged items and hedging instruments are compared. Typical regulations are accounting regulations set by the business entity's internal hedging policy or those set by governing regulatory bodies. Example governing regulatory bodies are the International Accounting Standards Board (IASB), which has promulgated the International Accounting Standard (IAS) 39, Financial Instruments: Recognition and Measurement, and the Financial Accounting Standards Board (FASB), which has promulgated the Financial Accounting Statement (FAS) 133, Accounting for Derivative Instruments and Hedging Activities. Example differences between the regulations may be the method used by each and whether an effectiveness test, which measures the effectiveness of a hedging instrument in counterbalancing its corresponding hedged items, is required.

Conventional systems generate hedge accounting data for a hedging relationship data object. The accounting data is generated based on a particular rule set a user indicates should be used for the data generation. The rule set is used to generate the accounting data according to a particular set of accounting regulations, e.g., IAS 39. The generated accounting data is stored as a data object linked to the hedging relationship for which it is generated.

It is often the case that particular hedging instruments/hedged items associations are better suited for application of one rule set than for application of other rule sets. It is also often desirable or required for a business entity to provide for the same hedged items and hedging instruments, accounting data generated according to a number of different rule sets. For example, an entity doing business in a number of regions may be required to conform to requirements of different local regulatory agencies. Conventional systems do not provide for generation and storage of multiple accounting data sets for a particular hedging relationship, i.e., a particular association of hedging instruments and risk exposures, according to different rule sets. In addition, conventional systems do not provide for a particular risk exposure and a particular hedging instrument to be assigned to multiple relationships that vary with respect to their risk exposure/hedging instrument associations, for example, where each relationship is best suited for a corresponding rule set. To provide for generation and storage of different sets of data for the same hedging relationship and/or to provide for a particular risk exposure or hedging instrument to be assigned to different hedging relationships, a user of conventional systems must enter the same risk exposures and hedging instruments multiple times, each for one of the data sets to be generated, which wastes data entry time and memory space, and often causes confusion since a particular risk exposure or instrument is stored multiple times as separate risk exposures or instruments.

### BRIEF DESCRIPTION OF THE DRAWINGS

FIG. 1 is a block diagram that illustrates example components of a system, according to an example embodiment of the present invention.

FIG. 2 is a flowchart that illustrates an example procedure that may be performed for generation and management of hedge accounting related data objects, according to an example embodiment of the present invention.

FIG. 3 is a screenshot of an example hedge plan list of a valuation area, according to an example embodiment of the present invention.

FIG. 4a is a screenshot in which an exposures tab of a data objects management display is selected, according to an example embodiment of the present invention.

FIG. 4b is a screenshot in which a hedged items tab of a data objects management display is selected, according to an example embodiment of the present invention.

FIG. 4c is a screenshot in which a hedging relationship tab of a data objects management display is selected, according to an example embodiment of the present invention.

FIG. 5 shows an example split-screen in which accounting data generated for a particular hedging relationship for multiple valuation areas may be displayed side-by-side, according to an example embodiment of the present invention.

FIG. 6a is a diagram which illustrates logical associations between data objects, according to a conventional system.

FIG. 6b is a diagram that illustrates example logical associations between data objects, according to an example embodiment of the present invention.

### DETAILED DESCRIPTION

Embodiments of the present invention relate to a hedge accounting data management computer system and method that may provide for assignment of particular risk exposures, hedging instruments, and/or combinations thereof to multiple hedging relationships that may vary with respect to their risk exposure/hedging instrument associations, each hedging relationship corresponding to a particular one of a plurality of rule sets, e.g., the particular method and regulations to be applied when generating hedge accounting data for the corresponding hedging relationship. Embodiments of the present invention relate to a computer system and method for generation and storage of hedge accounting data for a particular hedging relationship according to multiple rule sets. The computer system may include a computer program written in any conventional computer language, and in particular in an object oriented computer language. Example computer languages that may be used to implement the computer system and method of the present invention may be Java, Extensible Markup Language (XML), C++, or a combination thereof.

### OVERVIEW OF EXAMPLE SYSTEM

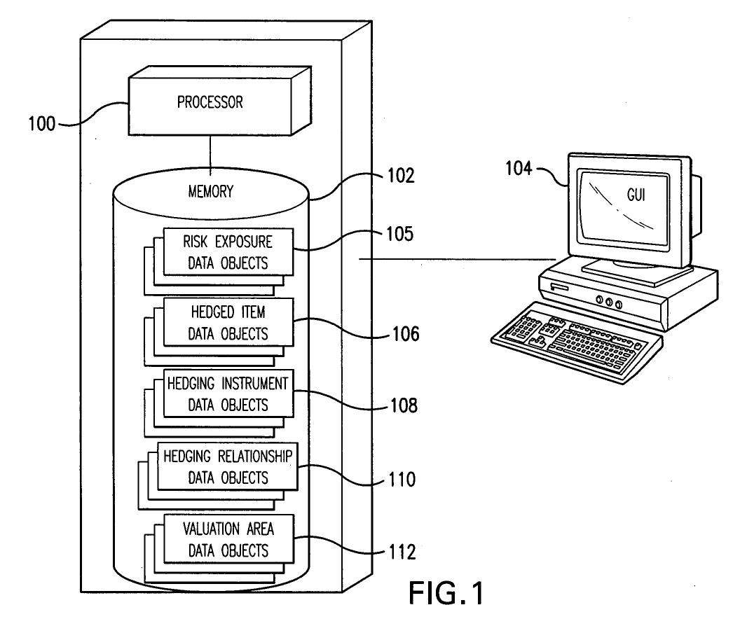

FIG. 1 is a block diagram that illustrates components of a system according to an example embodiment of the present invention. A processor 100 may receive input from a user pertaining to risk exposures and hedging instruments. The processor 100 may store a corresponding plurality of exposure data objects 105 and hedging instrument data objects 108 in a memory 102. Based on user input, the processor 100 may associate particular hedging instruments with particular exposure risks by generating and storing in the memory 102 hedged item data objects corresponding to risk exposure data objects 105 selected for hedging, and hedging relationship data objects 110 to which particular hedged item data objects 106 and hedging instrument data objects 108 may be assigned. A hedging relationship may indicate that the hedging instruments of the hedging relationship offset risk to which an entity is exposed because of the hedged items of the hedging relationship, or more particularly because of the risk exposures to which the hedged items correspond. A user may input such an association of hedged items to hedging instruments, for example by creating a new hedging relationship data object 110, and selecting from a list of stored hedged items and stored hedging instruments, those that are to be associated with the created hedging relationship data object 110.

The processor 100 may store in the memory 102 a plurality of rule sets according to which hedged items and hedging instruments may be evaluated and according to which hedge accounting data relating to the hedged items and hedging instruments may be generated. Each rule set, which may correspond to, e.g., IAS 39 or FAS 133, may be stored as a rule set data object 112, also referred to herein as a “valuation area data object.” The processor 100 may associate each hedging relationship data object 110 to a particular valuation area data object 112.

Risk exposure, hedged item, hedging instrument, and hedging relationship data objects may be accessed via a valuation area data object 112. The processor 100 may provide data for generating an interactive display at a graphical user interface (GUI) 104, via which the user may input and manipulate the data objects stored in the memory 102. The display may include valuation areas corresponding to valuation area data objects 112.

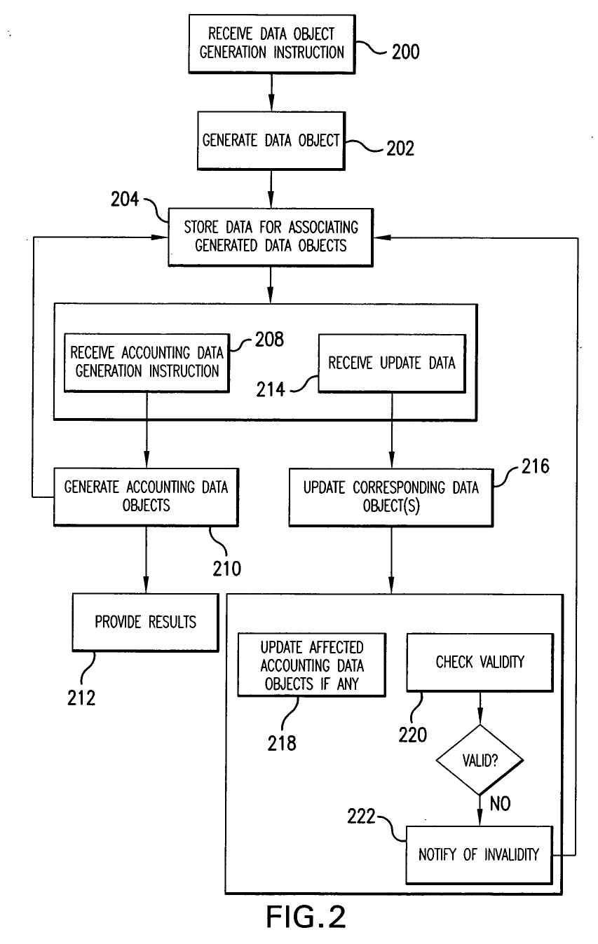

The system and method according to the present invention may provide for a user to create risk exposure, hedged item, hedging instrument, and hedging relationship data objects, and to update data associated with those objects. FIG. 2 is a flowchart that illustrates an example procedure that may be performed for generation and management of hedge accounting related data objects, according to an example embodiment of the present invention. At 200, the processor 100 may receive an instruction to generate a data object, e.g., a risk exposure, hedged item, hedging instrument, hedging relationship, or valuation area data object. In response to the instruction, the processor 100 may, at 202, generate the data object the processor 100 was instructed to generate.

The particular hedged item, and hedging relationship data objects created via a valuation area may be associated with the area's corresponding valuation area data object 112. Accordingly, at 204, the processor 100 may store data for associating the generated hedged item or hedging relationship data objects with the corresponding valuation area data object 112. The processor 100 may omit 204 where a valuation area data object 112 is generated, since a valuation area data object 112 need not be associated with other data objects. Additionally, in an embodiment of the present invention, all exposure data objects 105 and hedging instrument data objects 108 may be accessed from all valuation areas and associated with all valuation area data objects 112. In one example embodiment, exposure and hedging instrument data objects may be associated with particular hedge plans as will be described in more detail below. (It is noted that subsequent to 204, the processor 100 may refrain from performance of any further steps until an event, e.g., receipt of an accounting data generation instruction at 208 as described in detail below, or receipt of update data at 214 as described in detail below. Furthermore, after 204, either of 208 and 214 may occur first.)

In one embodiment of the present invention, for a single rule set, a plurality of corresponding valuation area data objects 112 may be generated at 202 and stored. Accordingly, even where the same rule set is applied to each of a plurality of hedging relationships, and associated hedged items and hedging instruments, the plurality of hedging relationships may be divided amongst a plurality of valuation areas.

Groupings of the data objects into hedge plans may be provided as a feature to enhance organization of the data objects and management of the business entity's underlying financial positions. A hedge plan may correspond to particular risk categories. For example, the hedge plans may include an interest rate plan, an exchange rate plan, and a forward contract plan, each representing different types of risk categories. It will be appreciated that plans may be defined by any user defined criteria.

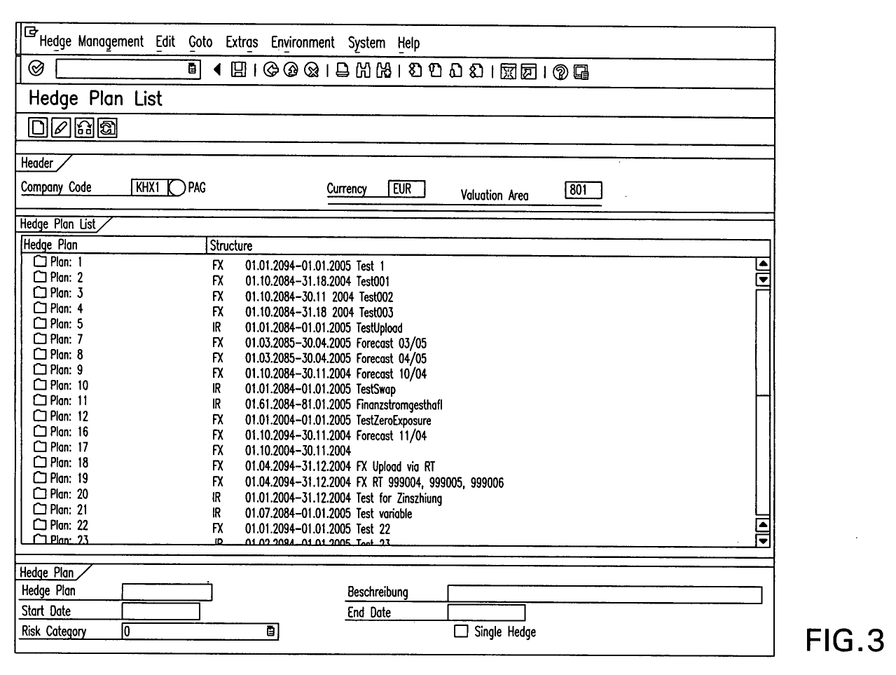

FIG. 3 is a screenshot of an example display via which the user may access hedge plans. For associating particular exposures, hedged items, hedging instruments, and hedging relationships, e.g., of a particular plan, with a particular valuation area, the user may select a particular valuation area object 112 by entering an object ID assigned to the valuation area object 112 and then proceed to further displays for managing the exposure, hedged item, hedging instrument, and hedging relationship data objects. The user may enter the object ID, e.g., by selecting the ID from a list box or by typing the ID into a fill-in data field, as shown at a top-right portion of the screenshot of FIG. 3, immediately above the “Hedge Plan List.” In one embodiment, a particular valuation area may be chosen as a default valuation area, so that if no particular valuation area is selected, then after selection of a particular hedge plan, management of exposure, hedged item, hedging instrument, and hedging relationship data objects is associated with the default valuation area's corresponding data object 112.

Upon selection of a hedge plan, the processor 100 may provide for selection of particular exposures, hedged items, hedging instruments, and hedging relationships that are to be associated with the active valuation area. It will be appreciated that for management of data objects associated with a hedge plan, activation or even existence of any valuation area is not required. For example, exposure data objects 105 and hedging instrument data objects 108 may be associated with a particular hedge plan even if not associated with a particular valuation area. Accordingly, in an embodiment of the present invention, all exposure data objects 105 and hedging instrument data objects 108 may be accessed from all valuation areas and associated with all valuation area data objects 112. In an example embodiment of the present invention, it may be required for each hedged item data object 106 and hedging relationship data object 110 to associated with no more than one particular valuation area data object 112.

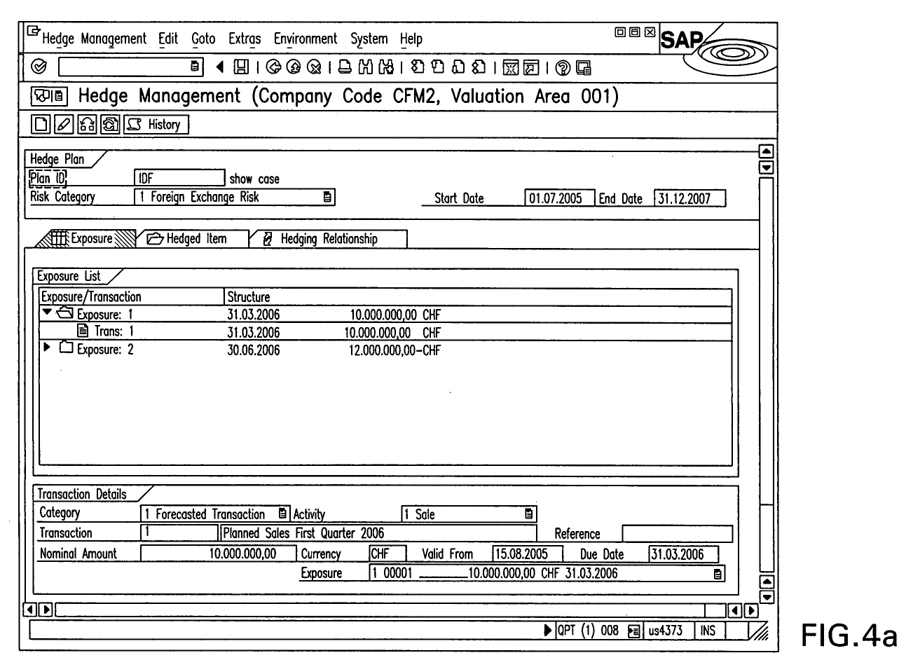

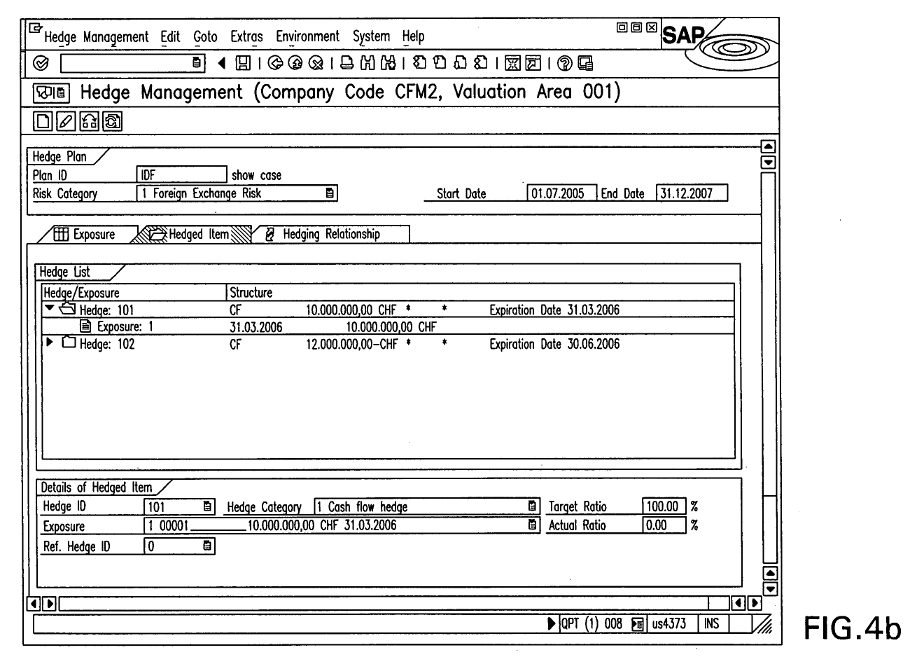

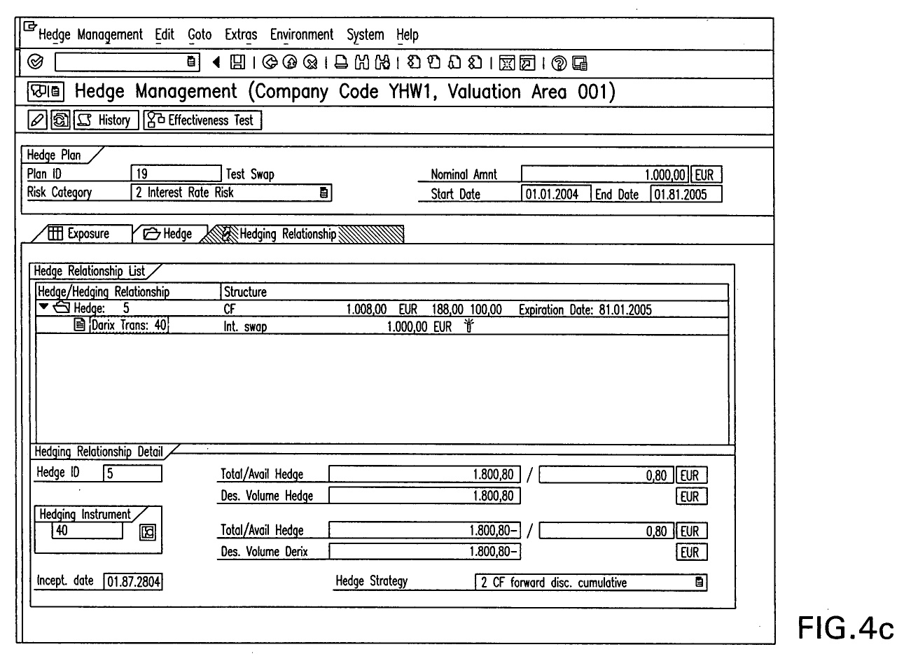

FIGS. 4a-c are screenshots of example valuation area displays that may be provided upon selection of a hedge plan. To create and/or manage data of exposure, hedged item, hedging instrument, and hedging relationship data objects of the plan and/or valuation area, the user may select the displayed tabs of FIGS. 4a-c, depending on the particular data to be entered or viewed.

A particular risk exposure, hedging instrument, or hedging relationship may be associated with multiple valuation area data objects 112. After generation of exposure data objects 105 and hedging instrument data objects 108, the user may, for example, within a first valuation area, select a generated exposure data object 105 and instruct the processor 100 to generate a corresponding hedged item data object 106 to be associated with the first valuation area and its corresponding data object 112. The user may also instruct the processor 100 to generate a hedging relationship data object 110 for associating the generated hedged item data object 106 with one or more hedging instrument data objects 108. For example, the generated hedged item data object 106 may be selected in the display shown in FIG. 4b , and, after selection of the hedging relationship tab, the hedging instrument data objects 108 to be associated by the hedging relationship data object 110 with the selected hedged item data object 105, may be selected, e.g., in a selection box shown at a bottom left portion of the hedging relationship display shown in FIG. 4c .

Within a second valuation area, the user may again select the same exposure data object 105 for which the hedged item data object 106 of the first valuation area was generated, and instruct the processor 100 to generate another hedged item data object 106 for the selected exposure data object 105. At 202, the processor 100 may generate a new hedged item data object 106 corresponding to the selected exposure data object 105 and may, at 204, associate the new hedged item data object 106 with the second valuation area data object 112. Accordingly, the same exposure may correspond to two different hedged item data objects 106, each associated with different valuation area data objects 112. Similarly, for the second valuation area, a new hedging relationship data object 110 may be generated. The new hedging relationship data object 110 may associate the new hedged item data object 106 with the same hedging instrument data objects 108 with which the hedged item data object 106 of the first valuation area was associated. Accordingly, a single exposure data object 105 (indirectly through corresponding hedged item data objects 106) and a single hedging instrument data object 108 may be associated with a plurality of hedging relationship data objects 110, where each of the hedging relationship data objects 110 is of a different valuation area. Furthermore, a single hedging relationship defined by an association of particular hedging instruments to particular exposures may be associated with a plurality of valuation areas (by generating for each valuation area data object 112 a corresponding hedging relationship data object 110 that associates hedged item data objects 106 with hedging instrument data objects 108).

In one embodiment of the present invention, a particular risk exposure and/or hedging instrument may be associated with a first hedging relationship that is associated with a first valuation area and may also be associated with a second hedging relationship that is associated with a second valuation area. For example, in the first valuation area, the user may select the hedging relationship tab as shown in FIG. 4c . The user may then create a new hedging relationship data object 110, select hedged item data objects 106 corresponding to one or more exposures, and select hedging instrument data objects 108 to counterbalance the risk of the exposures of the hedging relationship. The processor 100 may then, at 204, associate the selected hedged item data objects 106 and hedging instrument data objects 108 with the hedging relationship data object 110.

In a second valuation area, the procedure of FIG. 2 may repeated, e.g., if the user again selects the hedging relationship tab and creates a new hedging relationship 110 associated with the valuation area object 112 corresponding to the second valuation area. In response to the selection, the processor 100 may, at 202, generate a corresponding hedging relationship data object 110. For the newly created hedging relationship data object 110, the user may select hedged item data objects 106 corresponding to one or more of the same risk exposures that are associated with the hedging relationship created in the first valuation area. The same risk exposures may be accordingly associated with a first hedging relationship of the first valuation area and with a second hedging relationship of a second valuation area. The user may then select hedging instrument data objects 108 to be associated with the new hedging relationship data object 110. The selected hedging instrument data objects 108 may different than those associated with the hedging relationship data object 110 of the first valuation area, although the exposures to which each hedging relationship data object 110 associates the hedging instrument data objects 108 are different. Accordingly, while a group of exposures/hedging instruments may be associated with a single hedging relationship in one valuation area, they may be divided among multiple hedging relationships in another valuation area.

### Accounting Data Generation

In an embodiment of the present invention, the system and method may provide for automatic generation of hedge accounting data for multiple valuation areas in response to a single user instruction. The accounting data may be stored as accounting data objects. At 208, the processor 100 may receive an accounting-data generation instruction, in response to which the processor 100 may, at 210, generate accounting data objects. The generated accounting data objects may be generated for and associated with corresponding hedging relationship data objects 110. For example, the generated hedge accounting data may include data that indicates an effectiveness of a corresponding hedging relationship. Accordingly, after generation of the accounting data objects, the processor 100 may repeat 204 to associate the generated accounting data objects with corresponding hedging relationship data objects for which the accounting data objects were generated.

Where accounting data is generated for a particular hedging relationship and for multiple valuation areas, multiple accounting data objects may be stored for and associated with the particular hedging relationship data object. Each of the accounting data objects may be associated with and include data generated for a corresponding one of the multiple valuation areas. The data generated for a hedging relationship of a particular valuation area may be based on application of a particular method and rule set of the valuation area, e.g., IAS 39 or FAS 133, to the hedging relationship. For example, if a valuation area is associated with a rule set that requires effectiveness testing, then when a user instructs the processor 100 to create or update data for a hedging relationship of the valuation area, the system may perform the effectiveness testing for the hedging relationship of the valuation area.

For example, the processor 100 may receive selections of a subset or all of the valuation areas for activation, i.e., a rule set activation instruction or instructions. After activation, the user, through the GUI 104, for example, may cause the processor 100 to receive a single instruction to generate data, e.g., financial reports, for hedging relationships. In response to this single data generation instruction, the processor 100 may, at 210, generate the data for hedging relationships of each of the multiple activated valuation areas in accordance with the area's corresponding rule set. Alternatively, within a first valuation area, the user may instruct the processor 100 to generate the accounting data for all or selected valuation areas. The processor 100 may thereby generate data for a particular hedging relationship in accordance with rule sets of multiple activated valuation areas in response to a single data generation instruction, since the particular hedging relationship may be associated with multiple activated valuation areas.

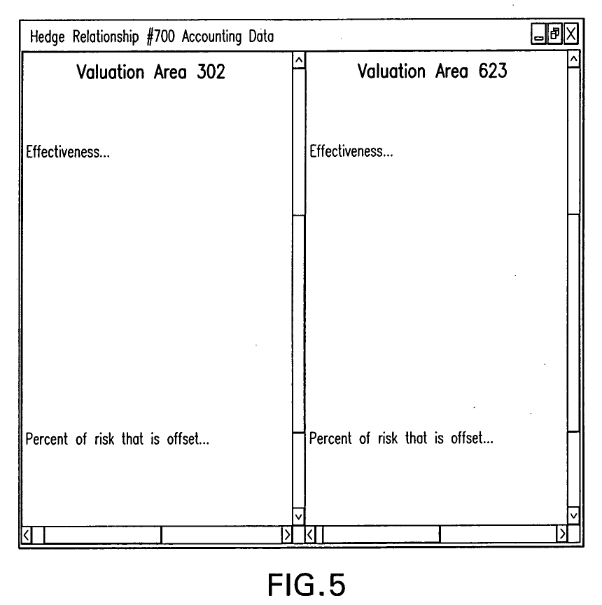

In an embodiment of the present invention, when the processor 100 generates accounting data for particular hedging relationships, the processor 100 may, at 212, display the generated accounting data. For example, the processor 100 may display simultaneously and side-by-side the accounting data of multiple valuation areas with which the particular hedging relationships are associated, e.g., as shown in FIG. 5.

In an embodiment of the present invention, the processor 100 may, at 210, generate for each valuation area financial reports regarding all exposures, hedged items, hedging instruments, and hedging relationships of the valuation area in combination. For example, a report may provide the total risk, total hedged risk, and total unhedged risk to which a business entity is exposed due to all of its transactions. The reports may vary depending on the valuation areas for which they are generated, e.g., because of the different rules applied during generation of the data, or because of the different hedging relationships assigned to the different valuation areas.

### Data Updates

Data of exposure, hedged item, hedging instrument, and hedging relationship data objects may be updated. At 214, the processor 100 may receive update data, e.g., from a user. In response to receipt of the update data, the processor 100 may, at 216, update a stored data object corresponding to the exposure, hedged item, hedging instrument, or hedging relationship for which the update data was received.

Updates may be required, e.g., if a business entity's positions change. Example changes may be where a note matures, a new instrument is acquired and incorporated into an exposure to which one or more hedged item data objects 106 may correspond, a new hedging instrument is acquired for counterbalancing the exposure of a relationship's hedged item, etc. These changes may require updates to not only data of exposure, corresponding hedged item, and hedging instrument data objects, but also to hedging relationships, since different hedged item/hedging instruments associations may be require in accordance with the entity's changed positions. Accordingly, in response to receipt of data for updating one data object, e.g., corresponding to an exposure, the processor 100 may, at 216, update three data objects: the exposure data object 105, the corresponding hedged item data object(s) 106, and the hedging relationship data object(s) 110 with which the hedged item data object(s) 106 is associated.

Since a particular exposure or hedging instrument data object may be associated with multiple valuation area data objects 112, therefore, with one entry by a user of update data for an exposure or hedging instrument data object, the updates may be reflected in all valuation areas. In addition, all hedged item data objects 106 of all valuation areas that correspond to the updated exposure may be updated in response to the single entry. Changes may therefore be made to multiple valuation areas without requiring the user to access each of the multiple valuation areas.

other changes may include amendments by a regulatory body to its accounting standards or amendments by the business entity of its internal hedging policy, i.e., changes to the valuation area rule set. Valuation area data objects 112 may therefore be updated. Such changes may be reflected in the accounting data objects associated with the valuation area data object 112 that corresponds to the changed rule set. If a particular change is implemented for a number of rule sets, the user may activate valuation area objects 112 that correspond to changed rule sets, and may thereby instruct the system to update the accounting data objects associated with all of the valuation area objects 112 that correspond to changed rule sets. In response to a single user instruction, the processor 100 may, at 218, automatically update the accounting data objects (if any have been previously generated) associated with all selected valuation area objects 112. For example, a previously generated accounting data object may be deleted and a new one may be generated and stored in its place. In one embodiment, the user may indicate the change in a first valuation area and, within the first valuation area, identify the other valuation areas to which the update applies.

In one embodiment, in response to updates to exposure, hedging instrument, and hedging relationship data objects, the processor 100 may, at 218, update corresponding accounting data objects (if any have been previously generated), since data of the corresponding accounting data objects may be outdated in light of the changes to the underlying exposure, hedging instrument, and/or hedging relationship data objects upon which the accounting data objects are based. In response to the change to the underlying data objects, the processor 100 may, at 218, automatically update accounting data objects of multiple valuation areas that were previously generated for hedging relationships affected by the underlying changes.

Changes to underlying exposure or hedging instrument data objects of a particular hedging relationship may invalidate the hedging relationship according to one or more valuation area's rule sets. For example, a rule set may require that hedging instruments of a hedging relationship counterbalance risk of a hedged item of the hedging relationship by a certain percentage which may have been met prior to, but not after, the update to the underlying data objects. Similarly, changes to a valuation area rule set may invalidate hedging relationships associated with the changed rule set, e.g., where the change includes a different required percentage of risk offset. According to an embodiment of the present invention, when the processor 100 receives, at 214, update data of underlying data objects of a hedging relationship, or when a change is made to a rule set(s) of one or more valuation areas, the processor 100 may, at 220, check whether any hedging relationships have become invalid due to the updates. If the processor 100 determines that one or more hedging relationships have been rendered invalid, the processor 100 may, at 222, generate an alert to notify of the hedging relationship's invalidity, and post it in all valuation areas in which one or more hedging relationships have become invalid due to the update. If a determination of invalidity is not made, the processor 100 may refrain from performance of further steps, e.g., until the processor 100 receives further instructions. Alternatively, the processor 100 may generate a message notifying of validity of all hedging relationships. (It is noted that the processor 100 may perform 218 and 220-222 in parallel or in sequence. The precise sequence is therefore not illustrated in FIG. 2.)

In response to the alert, a user may choose to delete the invalidated hedging relationship. Alternatively, the user may choose to create and/or assign different hedged items and/or hedging instruments to the hedging relationship in order to validate the hedging relationship. In this instance, 204 may be repeated.

### Logical Association of Data Objects

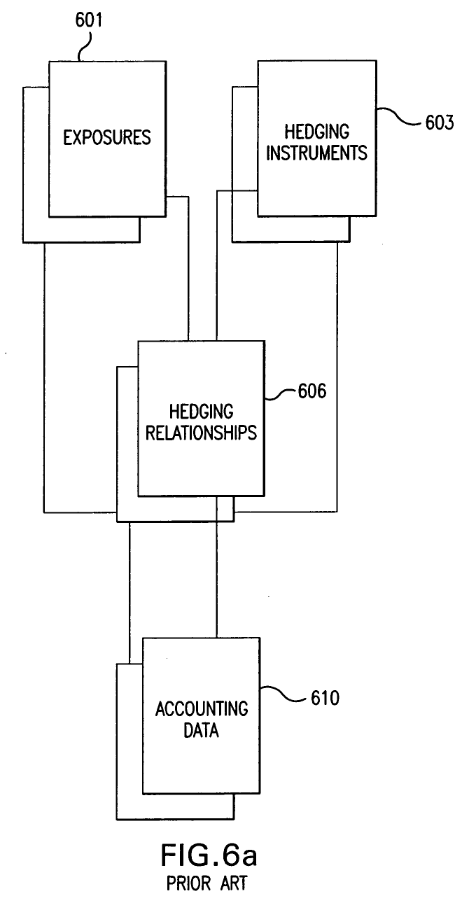

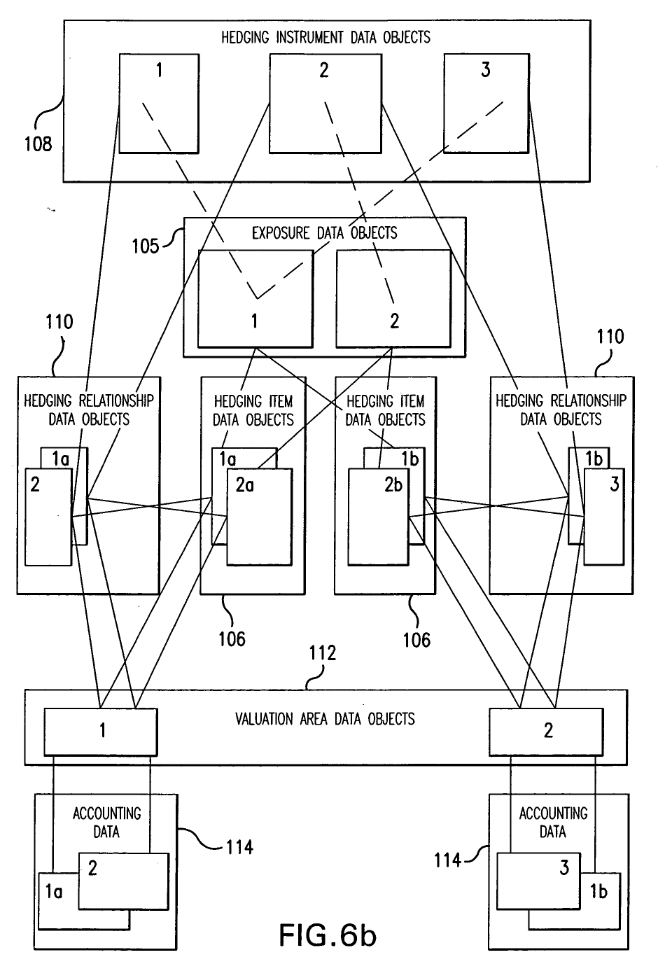

FIG. 6a illustrates a logical association of data objects according to conventional systems.

In a conventional system, a particular exposure 601 (or a particular portion thereof) and a particular hedging instrument 603 (or a particular portion thereof) are associated with, at most, a single corresponding hedging relationship 606, and are thereby associated with each other. For each hedging relationship 606, accounting data 610 is generated according to a single rule set selected for the hedging relationship 606.

FIG. 6b illustrates an example logical association of data objects according to an example embodiment of the present invention. A particular exposure (or a particular portion thereof), via corresponding hedged item data objects 106, and a particular hedging instrument (or a particular portion thereof) may be associated with a plurality of hedging relationships, where each of the plurality of hedging relationships is associated with a particular corresponding valuation area (and valuation area data object 112), where each valuation area (and valuation area data object 112) corresponds to a particular rule set. For example, for each hedged item data objects 106, a pointer may be stored in the memory 102 that points to a corresponding exposure data object 105, and/or vice versa. For multiple hedged item data objects 106, pointers to a same exposure data object 105 may be stored if each of the multiple hedged item data objects 106 is associated with a different valuation area.

Similarly, for each valuation area data object 112, a plurality of pointers may be stored that point to locations in the memory 102 where data of corresponding hedged item data objects 106 and corresponding hedging relationship data objects 110 are stored to link the corresponding hedged item data objects 106 and the corresponding hedging relationship data objects 110 to the valuation area data object 112. Similarly, for each hedging relationship data object 110, pointers may be stored pointing at locations where data of corresponding hedging instrument data objects 108 and hedged item data objects 106 are stored to link the corresponding hedging instrument data objects 108 and hedged item data objects 106 (and therefore indirectly particular exposure data objects 105) to the hedging relationship data object 110.

Alternatively, a table or tables may be stored in the memory 102 that identifies each of or some of the exposure, hedged item, valuation area, hedging relationship, and hedging instrument data objects, and for each identified valuation area data object 112, and for each identified data object, particular ones of other data object types that correspond to it. Accordingly, hedged item (and, indirectly, exposure), hedging instrument, and hedging relationship data objects may be linked to particular valuation area data objects 112. Additionally, hedged item (and, indirectly, exposure) and hedging instrument data objects may be linked to particular hedging relationship data objects 110.

An example of an association of a single exposure and/or hedging instrument to a plurality of hedging relationships is shown in FIG. 6b . For example, hedged item data object 2a of valuation area data object 1 and hedged item data object 2b of valuation area 2 may both be generated for and associated with exposure data object 2. Hedged item data object 2a may be associated with hedging relationship data object 1a, and hedged item data object 2b may be associated with hedging relationship data object 1b. Accordingly, exposure data object 2 and hedging instrument 2 may each be associated with two hedging relationship data objects (1aand 1b). It is noted that since the hedging relationship data objects 1a and 1b associate, at least indirectly, the same hedging instrument data object 108 (2) with the same exposure data object 105 (2), the hedging relationship data objects 1a and 1b may be the same but for that hedging relationship data object 1a is associated with valuation area data object 1 and hedging relationship data object 1b is associated with valuation area data object 2.

Where multiple hedging relationship data objects 110 for a single hedging relationship are stored, e.g., hedging relationship data objects la and 1b, a change may be made to the hedging relationship with respect to one valuation area, without causing the change to be reflected in the hedging relationship with respect to the other valuation areas. For example, an additional hedging instrument data object 108 and/or hedged item data object 106 may be associated with one of the hedging relationship data objects 110, but not with other ones of the hedging relationship data objects 110.

In an embodiment of the present invention, the system and method may provide for linking a single hedged item or hedging instrument to multiple hedging relationships upon satisfaction of a condition that the multiple hedging relationships are associated with different valuation areas. For example, hedging instrument data object 2 may be associated with both hedging relationship data objects 1aand 1b, since hedging 1arelationship data objects 1aand 1b are associated with different valuation area data objects 112. The system and method may prevent a linking of a hedged item (or a particular portion thereof) or hedging instrument (or a particular portion thereof) to multiple hedging relationships. For example, if an attempt is made to cause the invalid link, an error message may be displayed.

In an embodiment of the present invention, a particular exposure data object 105 may be associated (indirectly via corresponding hedged item data objects 106) with a plurality of hedging relationship data objects 110, such that the exposure is associated with different hedging instruments in different ones of the hedging relationships with which the exposure is associated. For example, exposure data object 1 of FIG. 6b is associated, via hedged item data object 1a, with hedging relationship data object 2 of valuation area data object 1, and is thereby associated with hedging instrument data object 1, as represented by one of the broken lines leading from exposure data object 1. Exposure data object 1 is also associated, via hedged item data object 1b, with hedging relationship data object 3 of valuation area data object 2, and is thereby associated with hedging instrument data object 3, as represented by the other of the broken lines leading from exposure data object 1. Accordingly, for different valuation areas, risk of a single exposure may be offset by different hedging instruments. Similarly, for different valuation areas, a single hedging instrument may be used to offset risk of different hedged items (not shown). For example, hedging relationship data objects 2 and 3 are of different valuation areas. Therefore, although hedging instrument data object 3 is associated with hedging relationship data object 3 and therefore assigned to offset risk of exposure data object 1, hedging instrument data object 3 may also be associated with hedging relationship 1a(not shown) and assigned to offset risk of exposure 2.

Each valuation area may be used for generating accounting data 114 for the hedging relationships of the valuation area. For example, a valuation area to which valuation area data object 1 corresponds may be used for generating accounting data 1aand 2; and a valuation area to which valuation area data object 2 corresponds may be used for generating accounting data 1b and 3. Since valuation areas may correspond to different rule sets according to which the accounting data is generated, e.g., according to IAS 39 and FAS 133, different accounting data may be generated for a particular association of a hedging instrument with an exposure. For example, accounting data 1agenerated for and associated with valuation area data object 1, and accounting data 1b generated for and associated with valuation area data object 2, may each be associated with a hedging relationship that associates hedging instrument data object 2 and exposure data object 2 (via different hedged item data objects 106). Accounting data 1amay be associated with hedging relationship data object 1a, and accounting data 1b may be associated with hedging relationship data object 1b which matches hedging relationship data object 1a. However, accounting data 1aand 1b may differ since they are generated for different valuation areas.

Those skilled in the art can appreciate from the foregoing description that the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A hedge accounting data management method, comprising:
for a particular hedging relationship that associates at least one hedging instrument with at least one risk exposure, and in response to a single hedge accounting data generation instruction, generating multiple sets of hedge accounting data according to respective ones of a plurality of hedge accounting rule sets.

2. The hedge accounting data management method of claim 1, further comprising:
storing a plurality of hedging relationship data objects that correspond to the particular hedging relationship; and
associating each of the plurality of hedging relationship data objects with a corresponding one of the plurality of hedge accounting rule sets.

3. The hedge accounting data management method of claim 1, further comprising:
simultaneously displaying the hedge accounting data generated according to the plurality of hedge accounting rule sets.

4. The hedge accounting data management method of claim 1, further comprising:
receiving a rule set activation instruction identifying at least one of the plurality of hedge accounting rule sets;
wherein, in response to the single hedge accounting data generation instruction, the generating step includes generating hedge accounting data automatically for all hedging relationships that are associated with any of the at least one of the plurality of hedge accounting rule sets identified in the rule set activation instruction.

5. The hedge accounting data management method of claim 1, further comprising:
in response to update data for changing data of at least one of the particular hedging relationship, the at least one hedging instrument, and the at least one risk exposure:
updating the data of the at least one of the particular hedging relationship, the at least one hedging instrument, and the at least one risk exposure; and
generating new hedge accounting data according to at least one of the plurality of hedge accounting rule sets for at least one of:
(a) the updated hedging relationship;
(b) the at least one updated hedging instrument;
(c) the at least one updated risk exposure; and
(d) at least one hedging relationship associated with at least one of:
(i) the at least one updated hedging instrument; and
(ii) the at least one updated risk exposure.

6. The hedge accounting data management method of claim 1, further comprising:
in response to data indicating a change in a particular one of the plurality of hedge accounting rule sets:
changing the particular one of the plurality of hedge accounting rule sets to produce a changed hedge accounting rule set; and
generating new hedge accounting data for the particular hedging relationship according to the changed hedge accounting rule set.

7. The hedge accounting data management method of claim 1, further comprising:
in response to data indicating a change in at least one of the particular hedging relationship, the at least one hedging instrument, and the at least one risk exposure:
determining whether the particular hedging relationship is valid for each of at least one of the plurality of hedge accounting rule sets; and
if it is determined that the particular hedging relationship is invalid for a particular hedge accounting rule set, outputting a message indicating that the particular hedging relationship is invalid for the particular hedge accounting rule set.

8. The hedge accounting data management method of claim 1, further comprising:
in response to data indicating a change in a particular one of the plurality of hedge accounting rule sets:
determining whether the particular hedging relationship is valid for the changed particular hedge accounting rule set; and
if it is determined that the changed particular hedging relationship is invalid for the changed hedge accounting rule set, outputting a message indicating that the particular hedging relationship is invalid for the changed particular hedge accounting rule set.

9. The hedge accounting data management method of claim 1, further comprising:
for each of the plurality of hedge accounting rule sets, storing at least one corresponding rule set data object; and
for the particular hedging relationship, storing a plurality of hedging relationship data objects, each of the plurality of hedging relationship data objects corresponding to a different one of the rule set data objects.

10. The hedge accounting data management method of claim 1, further comprising:
for each of the plurality of hedge accounting rule sets, storing at least one corresponding rule set data object;
for each of the rule set data objects, providing a corresponding display area via which a user has access to at least one of a risk exposure, a hedging instrument, a hedging relationship, and a hedge accounting data that is associated with the rule set data object.

11. The hedge accounting data management method of claim 10, further comprising:
for each of the risk exposures, storing a corresponding exposure data object;
interpreting an interaction by the user with an object displayed in a display area corresponding to a first rule set data object as an instruction to generate at least one of (a) a first hedged item data object corresponding to a particular exposure data object and (b) a first hedging relationship data object corresponding to the particular hedging relationship; and
in response to the interaction:
generating the at least one of the first hedged item data object and the first hedging relationship data object; and
storing data that links the generated at least one of the first hedged item data object and the first hedging relationship data object to the first rule set data object.

12. The hedge accounting data management method of claim 11, further comprising:
interpreting an interaction by the user with an object displayed in a display area corresponding to a second rule set data object as an instruction to generate at least one of (a) a second hedged item data object corresponding to a particular exposure data object and (b) a second hedging relationship data object corresponding to the particular hedging relationship; and
in response to the interaction:
generating the at least one of the second hedged item data object and the second hedging relationship data object; and
storing data linking the generated at least one of the second hedged item data object and the second hedging relationship data object to the second rule set data object.

13. The hedge accounting data management method of claim 1, wherein:
at least one of the at least one hedging instrument and the at least one risk exposure is associated with the particular hedging relationship and another hedging relationship; and
the particular hedging relationship and the another hedging relationship are associated with different hedge accounting rule sets.

14. The hedge accounting data management method of claim 1, wherein at least one of the at least one hedging instrument and the at least one risk exposure is associated with the particular hedging relationship and another hedging relationship, further comprising:
for each of the plurality of hedge accounting rules sets, storing at least one rule set data object; and
for each of the particular and the another hedging relationships, storing a corresponding hedging relationship data object;
wherein each of the corresponding hedging relationship data objects is associated with a different one of the rule set data objects.

15. The hedge accounting data management method of claim 1, wherein the hedge accounting data generation instruction is a user initiated instruction.

16. A hedge accounting data management method, comprising:
assigning a risk exposure data object and a hedging instrument data object to a first hedging relationship data object for generation of hedge accounting data according to a first hedge accounting rule set;
assigning at least one of the risk exposure data object and the hedging instrument data object to a second hedging relationship data object for generation of hedge accounting data according to a second hedge accounting rule set; and
storing data that simultaneously links the at least one of the risk exposure data object and the hedging instrument data object to the first and second hedging relationship data objects.

17. The hedge accounting data management method of claim 16, wherein, to simultaneously link the risk exposure data object to the first and second hedging relationship data objects, a first hedged item data object that corresponds to the risk exposure data object is linked to the first hedging relationship data object, and a second hedged item data object that corresponds to the risk exposure data object is linked to the second hedging relationship data object.

18. The hedge accounting data management method of claim 16, further comprising:
in response to a single user-initiated instruction, generating the hedge accounting data according to the first hedge accounting rule set and the hedge accounting data according to the second hedge accounting rule set.

19. The hedge accounting data management method of claim 16, wherein the first and second hedging relationship data objects are associated with different combinations of risk exposures and hedging instruments.

20. A hedge accounting data management method, comprising:
storing for each of a plurality of hedge accounting rule sets at least one corresponding rule set data object;
assigning (a) a first hedged item data object corresponding to a risk exposure data object and (b) a hedging instrument data object to a first hedging relationship data object that is associated with a first rule set data object; and
at least one of:
(a) assigning a second hedged item data object corresponding to the risk exposure data object to a second hedging relationship data object that is associated with a second rule set data object; and
storing data that simultaneously links the first hedged item data object to the first hedging relationship data object and the second hedged item data object to the second hedging relationship data object; and
(b) assigning the hedging instrument data object to the second hedging relationship data object; and
storing data that simultaneously links the hedging instrument data object to the first and second hedging relationship data objects.

21. An article of manufacture comprising a computer-readable medium having stored thereon instructions adapted to be executed by a processor, the instructions which, when executed, define a hedge accounting data management method, the method comprising:
for a particular hedging relationship that associates at least one hedging instrument with at least one risk exposure, and in response to a single hedge accounting data generation instruction, generating multiple sets of hedge accounting data according to respective ones of a plurality of hedge accounting rule sets.

22. A method, comprising:
inputting a single data generation instruction that instructs a processor to generate a plurality of hedge accounting data for a particular hedging relationship that associates at least one hedging instrument with at least one risk exposure, each of the plurality of hedge accounting data to be generated according to a corresponding one of a plurality of hedge accounting rule sets.
